(19) United States
(12) Patent Application Publication
(10) Pub. No.: US 2014/0337656 A1
(43) Pub. Date: Nov. 13, 2014

(54) ENERGY MANAGEMENT SYSTEM

(71) Applicant: HON HAI PRECISION INDUSTRY CO., LTD., New Taipei (TW)

(72) Inventor: CHAO-JUI HUANG, New Taipei (TW)

(73) Assignee: HON HAI PRECISION INDUSTRY CO., LTD., New Taipei (TW)

(21) Appl. No.: 14/275,979

(22) Filed: May 13, 2014

(30) Foreign Application Priority Data
May 13, 2013 (TW) 102116945

(51) Int. Cl. G06F 11/30

(52) U.S. Cl. CPC G06F 11/3062
USPC 713/340

(57) ABSTRACT

An energy management system is connected to a power supply unit and a power switch. The energy management system includes a power supply monitor, a power supply connector, and a baseboard management controller (BMC). The power supply monitor is connected to the BMC through an intelligent platform management interface (IPMI). The power supply monitor is utilized to read, count and record power signals from the BMC, and send commands according the power signals to control the power switch.

### FIELD

The present disclosure relates to an energy management system.

### BACKGROUND

Power supply units usually lack the ability to measure and transmit energy consumption information.

### BRIEF DESCRIPTION OF THE DRAWING

Many aspects of the embodiments can be better understood with reference to the following drawings. The components in the drawings are not necessarily drawn to scale, the emphasis instead being placed upon clearly illustrating the principles of the presented embodiments. Moreover, in the drawings, like reference numerals designate corresponding parts throughout the several views.

FIG. 1 is a block diagram of an embodiment of energy management system, comprising a power supply monitor, a baseboard management controller (BMC), and a power supply connector.

FIG. 2 is a block diagram of an embodiment of the power supply monitor of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

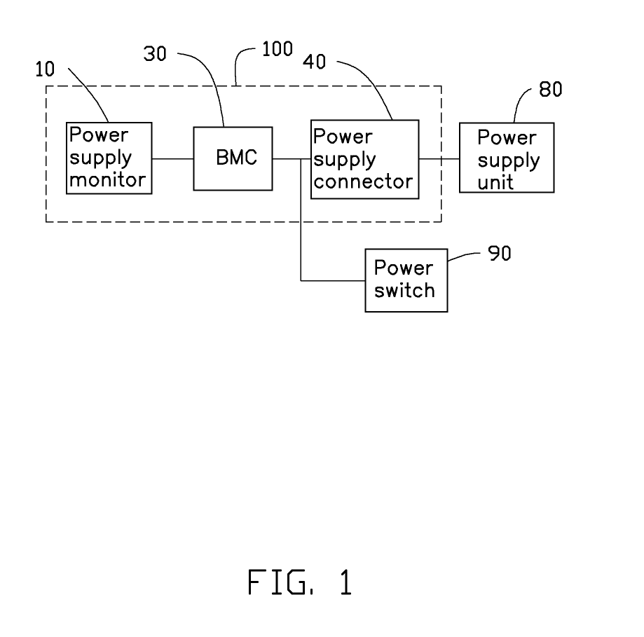

FIG. 1 illustrates an embodiment of an energy management system 100 of the present disclosure. In the embodiment, the energy management system 100 can comprise a power supply monitor 10, a baseboard management controller (BMC) 30, and a power supply connector 40. The energy management system 100 is connected to a power supply unit 80 of a server to manage the energy consumption information of the power supply unit 80. The energy management system 100 is connected to a power switch 90 to control the power switch 90.

The BMC 30 can be connected to the power supply unit 80 through the power supply connector 40 for detecting power signals from the power supply unit 80. The power supply monitor 10 can be connected to the BMC 30 through an intelligent platform management interface (IPMI). The power supply monitor 10 can receive the power signals from the BMC 30 through the IPMI, and then manages the power signals. The BMC 30 is connected to the power switch 90. The power supply monitor 10 controls the power switch 90 through the BMC 30.

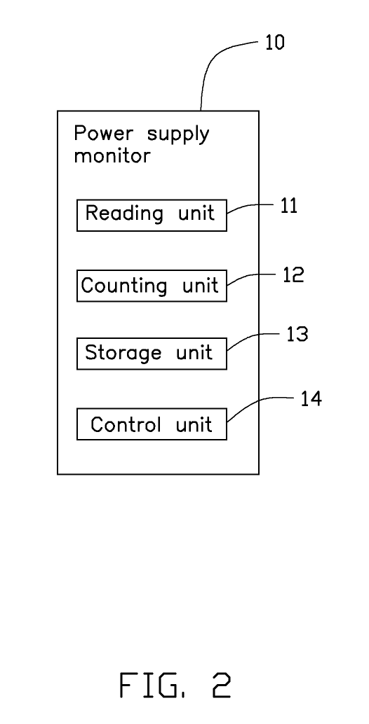

FIG. 2 illustrates that the power supply monitor 10 can comprise a reading unit 11, a counting unit 12, a storage unit 13, and a control unit 14. The reading unit 11 is utilized to read the power signals from the BMC 30. The counting unit 12 is utilized to count the power signals to obtain energy consumption information of the power supply unit 80. The storage unit 13 is utilized to record the energy consumption information in a preset period of time. The control unit 14 is utilized to control the BMC 30 through the IPMI to control the power switch 90. For example, analyzing peak periods and off-peak periods for usage of the servers in a same domain according to the energy consumption information of the servers during a month, recorded in the storage unit 13, and then constituting a task that power on some of the servers during the peak periods, and turns off some servers in the off-peak periods for conserving energy.

In another embodiment, according to the price trend of electricity, part of the servers can be turned off during the peak periods, and be turned on in the off-peak periods, in order to save money.

Even though numerous characteristics and advantages of the disclosure have been set forth in the foregoing description, together with details of the structure and function of the disclosure, the disclosure is illustrative only, and changes can be made in the details given, including matters of shape, size, and arrangement of parts within the principles of the disclosure to the full extent indicated by the broad general meaning of the terms in which the appended claims are expressed.

What is claimed is:

1. An energy management system connected to a power supply unit and a power switch, the energy management system comprising:
a power supply connector;
a baseboard management controller (BMC) connected to the power supply unit through the power supply connector for detecting power signals from the power supply unit, and connected to the power switch for controlling the power switch; and
a power supply monitor connected to the BMC, the power supply monitor comprising:
a reading unit to read the power signals from the BMC;
a counting unit to count the power signals to obtain energy consumption information of the power supply unit; and
a storage unit to record the energy consumption information in a preset period of time.

2. The energy management system of claim 1, wherein the power supply monitor further comprises a control unit to control the BMC to switch the power switch.
